(19) United States
(12) Patent Application Publication
(10) Pub. No.: US 2023/0164270 A1
(43) Pub. Date: May 25, 2023

(54) SYSTEMS AND METHODS OF PROVIDING AUTOMATED RESOLUTIONS

(71) Applicant: Rakuten Mobile, Inc., Tokyo (JP)

(72) Inventors: Dewa SISWANTO, Tokyo (JP); Rina TAKAMATSU, Tokyo (JP); Rinka MATSUMOTO, Tokyo (JP)

(21) Appl. No.: 17/456,377

(22) Filed: Nov. 24, 2021

(51) Int. Cl. H04M 3/51; H04M 3/523; G10L 15/26; G06N 5/00

(52) U.S. Cl. CPC H04M 3/5166; H04M 3/5235; G10L 15/26; G06N 5/003

(57) ABSTRACT

Systems and methods of solving inquiries in an automated manner are disclosed. In some embodiments, a method, includes converting auditory data into textual data, wherein the auditory data is of a voice with speech related to an inquiry. Additionally, a target automated resolution is selected for the inquiry from a plurality of automated resolutions based on the textual data and a resolution data structure of a plurality of resolution data structures. Each of the resolution data structures relates to an automated resolution of the plurality of automated resolutions.

### BACKGROUND

Customers call customer service centers in order to attempt to solve problems with their service. Generally, the provider of the service hires customer service representatives to answer the calls from the customers. Hiring this staff is expensive. Long wait times due to insufficient staff often causes dissatisfaction for the customer while waiting a long time to talk to a customer service representative. While these call centers sometimes have digital solutions that give the customer certain options from to select, the options are rigid, and the digital solutions are limited in an ability to discern details regarding the subject of the inquiry. This often results in the customer wanting to talk to the customer service representative.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of an automated customer resolution system, in accordance with some embodiments.

FIG. 2 is a block diagram of automated customer resolution software, in accordance with some embodiments.

FIG. 3 is a block diagram of automated customer resolution software, in accordance with some embodiments.

FIG. 4 is a call flow diagram of an embodiment of implementing customer service procedures, in accordance with some embodiments.

FIG. 5 is a visual representation of an automated decision tree, in accordance with some embodiments.

FIG. 6 is a flowchart related to a customer service method, in accordance with some embodiments.

FIG. 7-FIG. 9 are flowcharts that are implemented after the flowchart in FIG. 6 in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

(Optional, use when applicable) Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Systems and methods of implementing automated solutions to inquiries are disclosed in this description. In some embodiments, the systems and methods are used to provide answers or solutions to customer service inquiries. In some embodiments, a computer device is configured to convert audio data of speech with the inquiry into textual data. Rule based systems or artificial intelligence systems then search through resolution data structures that describe automated resolutions. In some embodiments, the automated resolutions are based on solutions used to solve past inquiries. Rule based systems or artificial intelligence systems are configured to select a target automated resolution from the various automated resolution based on the textual data with the customer inquiry. In some embodiments, the automated resolution selected is the one most likely to solve the inquiry in the textual data. In this manner, the system and methods are capable of deciphering how to solve the inquiry in an automated manner.

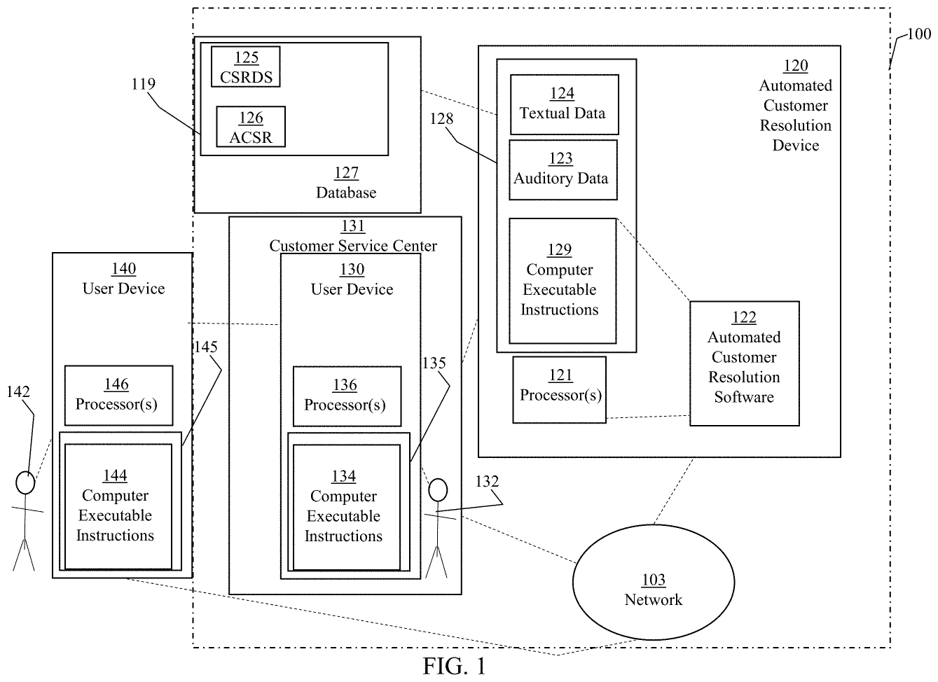

FIG. 1 is a block diagram of an automated customer resolution system 100, in accordance with some embodiments.

Automated customer resolution system 100 includes an automated customer resolution device 120 (which is a server(s) 120, in some embodiments), a database 127, and a user device 130. The automated customer resolution device 120 is a computer device that is operably connected to the database 127. Automated customer resolution device 120 is connected to a network 103 and is configured to manage the processing (e.g., writing and storing) of data 125, 126 (referred to generically or collectively as data) stored in non-transitory computer readable medium 119 in the database 127. In some embodiments, the network 103 includes a wide area network (WAN) (i.e., the internet), a wireless WAN (WWAN) (i.e., a cellular network), a local area network (LAN), and/or the like.

Data includes automated customer service resolutions (ACSR in FIG. 1) 126. Each of the automated customer service resolutions 126 includes executable instructions for implementing a set of automated procedures that helps to resolves a customer inquiry. A customer inquiry is a problem or request from a customer that use service procedures for resolution. Each of the automated customer service resolutions 126 includes executable instructions for implementing the service procedures in an automated manner to help resolve different customer inquiries. Data further includes customer service resolution data structures (CSRDS in FIG. 1) 125. Each of the customer service resolution data structures 125 relates to a different automated customer service resolution 126 of the automated customer service resolutions 126. In some embodiments, each of the customer service resolution data structures 125 describes the automated procedures implemented by one of the automated customer service resolutions 126. In some embodiments, each of the customer service resolution data structures 125 links each of the automated customer service resolutions 126 with one or more historical customer service inquires. In other words, previously received historical customer service inquiries are linked to the automated customer service resolutions 126 by the customer service resolution data structures 125, in accordance with some embodiments. In this manner, automated customer service resolutions 126 used to resolve previous customer service inquiries are linked by the customer service resolution data structures 125, in accordance with some embodiments.

In some embodiments, customer service resolution data structures 125 and automated customer service resolutions 126 have database formats written in one or more database languages. The database formats define the structure of the customer service resolution data structures 125, automated customer service resolutions 126. Exemplary database languages include JSON, ASCII, XML, and CSV. One of ordinary skill in the art would understand that JSON, ASCII, XML, and CSV are exemplary database languages and are not in any way limiting on the current disclosure. In some embodiments, the customer service resolution data structures 125 and automated customer service resolutions 126 are in database formats written in other suitable database languages. In some embodiments, the customer service resolution data structures 125 and automated customer service resolutions 126 are in database formats written in the same database language JSON, ASCII, XML, and CSV. In some embodiments, the customer service resolution data structures 125 and automated customer service resolutions 126 are in database formats written different database languages JSON, ASCII, XML, and CSV. For example, in some embodiments, some of the customer service resolution data structures 125 are in JSON and some of the automated customer service resolutions 126 are in XML.

The automated customer resolution device 120 is configured to manage the writing and storing of the customer service resolution data structures 125 and automated customer service resolutions 126 in the databases 127 and to perform other functionality including the automated procedures described herein. The automated customer resolution device 120 includes computer executable instructions 129 that are executable by one or more processors 121. The computer executable instructions 129 are stored on a non-transitory computer readable medium 128. In some embodiments, non-transitory computer readable medium 128 include a random-access memory (RAM), a read-only memory (ROM), an electrically erasable programmable ROM (EEPROM), optical disk storage, magnetic disk storage, other magnetic storage devices, combinations of the aforementioned types of computer-readable mediums, or any other medium that can be used to store computer executable code in the form of instructions or data structures that can be accessed by a computer device. When the one or more processors 121 of the automated customer resolution device 120 implement the computer executable instructions 129, the one or more processors 121 execute automated customer resolution software 122.

The automated customer resolution software 122 is configured to convert auditory data 123 into textual data 124. The auditory data 123 is of a captured voice with speech related to a customer service inquiry. In some embodiments, the textual data 124 includes a textual transcript of the customer service inquiry, which was originally captured as the auditory data 123. In some embodiments, the textual data 124 is ASCII data of the textual transcript. Thus, textual data 124 includes a textual representation of the customer service inquiry that was originally captured related to the customer service inquiry. In FIG. 1, the auditory data 123 and the textual data 124 are stored in the non-transitory computer readable medium 128.

In FIG. 1, the auditory data 123 originates from a user device 140 where a user 142 speaks into the user device 140 to describe the customer service inquiry. The speech from the user 142 is captured by the user device 140. The captured speech is converted into the auditory data 123 by the automated customer resolution software 122 in the automated customer resolution device 120. The user device 140 includes one or more processors 146 and computer executable instructions 144 that are stored on a non-transitory computer readable medium 145. In some embodiments, non-transitory computer-readable medium 145 include a random-access memory (RAM), a read-only memory (ROM), an electrically erasable programmable ROM (EEPROM), optical disk storage, magnetic disk storage, other magnetic storage devices, combinations of the aforementioned types of computer-readable mediums, or any other medium that can be used to store computer executable code in the form of instructions or data structures that can be accessed by a computer device. Examples of a user devices 140 include a cellular phone, a smart phone, a session initiation protocol (SIP) phone, a laptop, a smart watch, a personal digital assistant (PDA), a satellite radio, a global positioning system, a multimedia device, a video device, a digital audio player (e.g., MP3 player), a camera, a game console, a tablet, a smart device, and a wearable communication device.

In some embodiments, a call is established with the user device 140 associated with the user 142 (also referred to as the customer 142, in some embodiments). In some embodiments, the customer 142 calls a customer service center 131. The customer service center 131 is a location where customer service representatives, such as user 132, receive calls from a customer, such as customer 142. In some embodiments, customer service representatives operate in a geographically distributed manner such that there is no customer service center 131. A call is established between the user device 140, a user device 130 and the automated customer resolution device 120. In some embodiments, the call is a telephone call or other audible communication, such as voice of internet provider (VOIP). The user device 130 includes one or more processors 136 and computer executable instructions 134 that are stored on a non-transitory computer readable medium 135. In some embodiments, non-transitory computer-readable medium 135 include a random-access memory (RAM), a read-only memory (ROM), an electrically erasable programmable ROM (EEPROM), optical disk storage, magnetic disk storage, other magnetic storage devices, combinations of the aforementioned types of computer-readable mediums, or any other medium that can be used to store computer executable code in the form of instructions or data structures that can be accessed by a computer device. Examples of a user devices 130 include a cellular phone, a smart phone, a session initiation protocol (SIP) phone, a laptop, a smart watch, a personal digital assistant (PDA), a satellite radio, a global positioning system, a multimedia device, a video device, a digital audio player (e.g., MP3 player), a camera, a game console, a tablet, a smart device, and a wearable communication device. In some embodiments, the user device 130 is operated by a user 132 (also referred to as a customer service representative 132, in some embodiments).

However, prior to speaking to the customer service representative 132, the automated customer resolution device 120 is configured to transmit an audible inquiry request to the user device 140 during the call, wherein the audible inquiry request is playable through the user device 140 and asks for the customer 142 to describe a service problem. In response, the customer 142 speaks into the user device 140 with the customer service inquiry. The user device 140 is transmits the speech of the customer service inquiry to the automated customer resolution device 120 via network 103. The automated customer resolution software 122 is configured to convert the captured speech into the auditory data 123. The captured speech is transmitted from the user device 140 to the automated customer resolution device 120 as a response to transmitting the audible inquiry request. The automated customer resolution software 122 is configured to convert the auditory data 123 into textual data 124.

The automated customer resolution software 122 implemented by the automated customer resolution device 120 is configured to select a target automated customer service resolution 126 for the customer service inquiry from a plurality of automated customer service resolutions 126 based on the textual data 124 and a customer service resolution data structure 125 of a plurality of the customer service resolution data structures 125. In some embodiments, the automated customer resolution software 122 is configured to search through the customer service resolution data structures 125 and find the customer service resolution data structures 125 related to an automated customer service resolution 126 (i.e., the target automated customer service resolution 126) associated with a previous customer service inquiry that most closely matches the customer service inquiry from the textual data 124. Thus, unlike automated systems that simply request that a customer enter or speak a number related to a fixed solution, the automated customer resolution software 122 implemented by the automated customer resolution device 120 is configured to analyze the customer service inquiry in textual form and select the target automated customer service resolution 126 based on the customer service resolution data structures 125 that describe the automated customer service resolutions 126.

In some embodiments, the automated customer resolution software 122 implemented by the automated customer resolution device 120 simply executes the target automated customer service resolution 126 in response to selecting the target automated customer service resolution 126 for the customer service inquiry and without any further action. In some embodiments, the automated customer resolution software 122 implemented by the automated customer resolution device 120 sends an audible request to the user device 140 asking the customer 142 whether the customer 142 wants to implement the target automated customer service resolution 126. In some embodiments, customer input data is received by the automated customer resolution software 122 from the user device 140. The customer input data is a selection by the customer 142 of the target automated customer service resolution 126: In response, the target automated customer service resolution 126 is executed in response to receiving the customer input data. In still other embodiments, the automated customer resolution software 122 sends an audible request regarding whether the customer 142 would like to transfer the call to an customer service representative, such as the customer service representative 132. In some embodiments, the automated customer resolution software 122 is configured to receive customer input data, wherein the customer input data is from the user device 140 and is a selection by the customer 142 to transfer the call related to the customer service inquiry to the user device 130 associated with the customer service representative 132. In some embodiments, the automated customer resolution software 122 presents the customer service representative 132 in the customer service center 131 with an option through the user device 130 to execute the target automated customer service resolution 126 for the customer inquiry. In some embodiments, the target automated customer service resolution 126 for the customer service inquiry is executed in response to receiving customer service representative input data that the option has been selected by the customer service representative 132 through the user device 130.

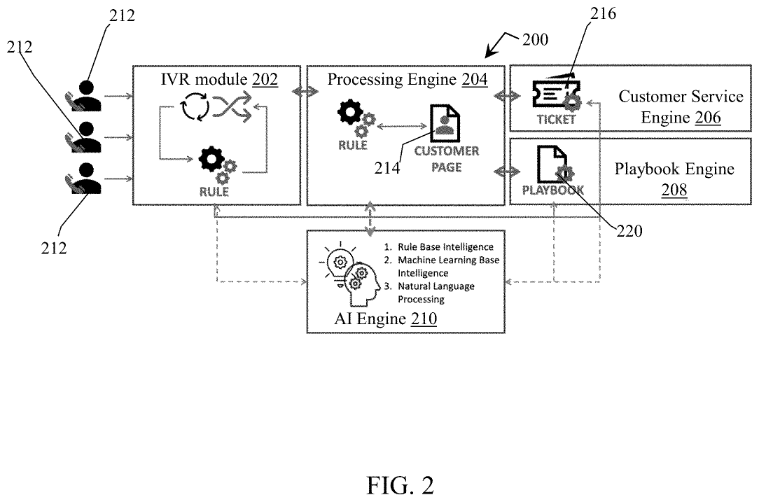

FIG. 2 is a block diagram of automated customer resolution software 200, in accordance with some embodiments.

The automated customer resolution software 200 corresponds to the automated customer resolution software 122 in FIG. 1 in accordance with some embodiments. The automated customer resolution software 200 includes an interactive voice response (IVR) module 202, a processing engine 204, a customer service engine 206, a playbook engine 208, and an artificial intelligence (AI) engine 210.

The IVR module 202 is configured to answer a customer service call from a customer 212. The IVR module 202 then plays a welcome message and request that the customer 212 provide auditory input identifying the language that the customer 212 prefers for the call. After the customer 212 provides the auditory input, the IVR module 202 sets the language preferences for the customer service call in accordance with the auditory input from the customer 212. The IVR module 202 receives the auditory inputs from the customer 212 and converts the auditory inputs into auditory data (e.g., auditory data 123 in FIG. 1).

The processing engine 204 is configured to convert the auditory data into textual data (e.g., textual data 124 in FIG. 1). In some embodiments, once the IVR module 202 obtains and sets the language preferences, the processing engine 204 is configured to transmit an auditory request for some basic identifying information from the customer 212 such as personal phone number, name, address etc. The customer 212 provides this information as an auditory input, which the IVR module 202 converts into auditory data. The processing engine 204 then converts the auditory data into textual data. In some embodiments, the processing engine 204 uses the textual data with the customer's identifying information to find a customer page 214. In some embodiments, the customer page 214 includes account data for the particular customer 212.

The processing engine 204 is then configured to transmit an auditory request that asks the customer 212 to audibly provide the customer inquiry. For example, the customer 212 is allowed to freely ask a question and/or state a problem. The auditory input with the customer inquiry is converted into auditory data by the IVR module 202. The processing engine 204 then converts the auditory data with the speech that includes the customer inquiry into textual data.

The customer service engine 206 then creates a digital customer service ticket 216. The digital customer service ticket 216 links the textual data with the customer inquiry to a service list. The service list is used to establish priority for the customer inquiries of different customers 212. For example, if ultimately it is established that the customer 212 is to speak with a customer service representative, the digital customer service ticket establishes the customer's place in line.

Once the AI engine 210 receives the digital customer service ticket 216 from the customer service engine 206, the AI engine 210 is configured to select a target automated customer service resolution (e.g., a target automated customer service resolution 126 in FIG. 1) for the customer service inquiry from a plurality of automated customer service resolutions (e.g., a plurality of automated customer service resolutions 126 in FIG. 1) based on the textual data (e.g., the textual data 124 in FIG. 1) and a customer service resolution data structure (e.g., a customer service resolution data structure 125 in FIG. 1) of a plurality of customer service resolution data structures (e.g., a plurality of customer service resolution data structures 125 in FIG. 1). In FIG. 2, the automated customer service resolutions are playbooks 220. Thus, a target playbook 220 is selected by the AI engine 210 based on a customer service resolution data structure that most closely matches the customer service inquiry in the textual data linked to the digital customer service ticket 216.

In some embodiments, the AI engine 210 is configured to search through the customer service resolution data structures and find the customer service resolution data structures related to a playbook 220 (i.e., the target automated customer service resolution 126) associated with a previous customer service inquiry that most closely matches the customer service inquiry from the textual data. Furthermore, if a selection is made that confirms that the selected playbook 220 implements the desired actions for the customer service inquiry, the AI engine 210 reinforces the link between the customer service inquiry and the target playbook 220 so that similar customer inquiries are resolved in a similar manner. If on the other hand, the target playbook 220 did not resolve the customer service inquiry, the AI engine 210 is configured to associate the actions of the customer service representative used to resolve the customer service inquiry (possibly in a new playbook 220) so that these actions are used to resolve similar customer service inquiries in the future.

Once the target playbook 220 is selected by the AI engine 210, the target playbook 220 is provided to the playbook engine 208. The playbook engine 208 is configured to implement the target playbook 220 so that the actions that solve the customer service inquiry are taken by the automated customer resolution software 200. In some embodiments, the playbook engine 208 lists the possible actions that the customer 212 can take, every service/action that can be taken to assist the customer 212, and provides a platform for knowledge-articles. In some embodiments, the playbook engine 208 implements the actions defined by the target playbook 220.

In some embodiments, at the end of customer service call, the AI engine 210 requests that the customer 212 state a satisfaction index. The satisfaction index is used as an indicator to train the AI engine 210 and continuously improve the AI engine's ability to appropriately select a target playbook 220 for customer service inquiries. In some embodiments, the customer/caller will still have option to be redirected to a customer service representative and get human assistance. This function will still be available in-case the AI engine 210 still is not yet trained to assist the customer 212 regarding a customer service inquiry.

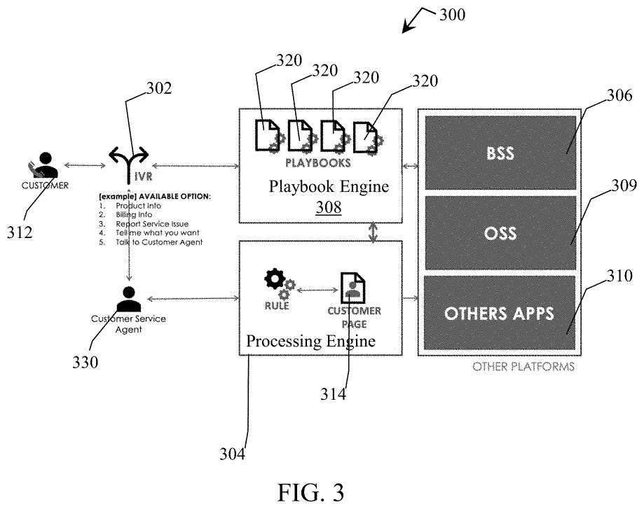

FIG. 3 is a block diagram of automated customer resolution software 300, in accordance with some embodiments.

The automated customer resolution software 300 corresponds to the automated customer resolution software 122 in FIG. 1 in accordance with some embodiments. The automated customer resolution software 300 includes an IVR module 302, a processing engine 304, a business service (BBS) engine 306, a playbook engine 308, an (OSS) 309, and other applications 310. In some embodiments, the BBS engine 306 is one example of the customer service engine 206 in FIG. 1.

The IVR module 302 is configured to answer a customer service call from a customer 312. The IVR module 302 then plays a welcome message and request that the customer 312 provide auditory input identifying the language that the customer 312 prefers for the call. After the customer 312 provides the auditory input, the IVR module 302 sets the language preferences for the customer service call in accordance with the auditory input from the customer 312. The IVR module 302 receives the auditory inputs from the customer 312 and converts the auditory inputs into auditory data (e.g., auditory data 123 in FIG. 1).

In FIG. 3, the welcome message states various options that a customer 312 can select from including, receiving product information, receiving billing information, reporting service issues, using a free inquiry option (i.e., Tell me what you want), and talking to a customer service representative 330 (also referred to as a customer service agent 330). In some embodiments, playbooks 320 are directly linked to particular options such as receiving product information, receiving billing information, report service issues. If the customer 312 selects these options, then the playbooks 320 are simply implemented by the playbook engine 308. Additionally, if the customer 312 selects to talk to the customer service representative 330, the BSS engine 306 takes over to connect the call to the user device of the customer service representative 330. However, if the customer 312 selects to talk to a customer service representative 330, the processing engine 304 is configured to transmit an auditory request that the customer 312 freely and audibly state their customer service inquiry. The IVR module 302 is configured to convert the audibly stated customer service inquiry into auditory data of the customer's speech of the customer service inquiry.

The processing engine 304 is configured to convert the auditory data into textual data (e.g., textual data 124 in FIG. 1). In some embodiments, once the IVR module 202 obtains and sets the language preferences, the processing engine 304 is configured to transmit an auditory request for some basic identifying information from the customer 312 such as personal phone number, name, address etc. The customer 312 provides this information as an auditory input, which the IVR module 302 converts into auditory data, in which then the processing engine 304 converts into textual data. In some embodiments, the processing engine 304 uses the textual data with the customer's identifying information to find a customer page 314. In some embodiments, the customer page 314 includes account data for the particular customer 312.

The processing engine 304 is configured to select a target automated customer service resolution (e.g., a target automated customer service resolution 126 in FIG. 1) for the customer service inquiry from a plurality of automated customer service resolutions (e.g., a plurality of automated customer service resolutions 126 in FIG. 1) based on the textual data (e.g., the textual data 124 in FIG. 1) and a customer service resolution data structure (e.g., a customer service resolution data structure 125 in FIG. 1) of a plurality of customer service resolution data structures (e.g., a plurality of customer service resolution data structures 125 in FIG. 1). In FIG. 1, the automated customer service resolutions are playbooks 320. Thus, a target playbook 320 is selected by the processing engine 304 based on a customer service resolution data structure that most closely matches the customer service inquiry in the textual data.

In some embodiments, the processing engine 304 is configured to search through the customer service resolution data structures and find the customer service resolution data structures related to a target playbook 320 (i.e., the target automated customer service resolution 126) associated with a previous customer service inquiry that most closely matches the customer service inquiry from the textual data. In some embodiments, the processing engine 304 is configured to recognize the category of the customer service inquiry by keyword recognition. A search is then performed of the customer service resolution data structures to find the closest match between the category and the previous customer service inquiries.

Once the target playbook 320 is selected by the processing engine 304, the target playbook 320 is provided to the playbook engine 308. The playbook engine 308 is configured to implement the target playbook 320 so that the actions that solve the customer service inquiry are taken by the automated customer resolution software 300. In some embodiments, the playbook engine 308 lists the possible actions that the customer 312 can take, every service/action that can be taken to help the customer 312, and provides a platform for knowledge articles. In some embodiments, the playbook engine 308 implements the actions defined by the target playbook 320.

In some embodiments, at the end of customer service call, the OSS 309 requests that the customer 312 state a satisfaction index. The satisfaction index is used as an indicator to the OSS 309 with respect to keyword and category selection. This helps the processing engine 304 to continuously improve the ability to appropriately select a playbook 320 for customer service inquiries.

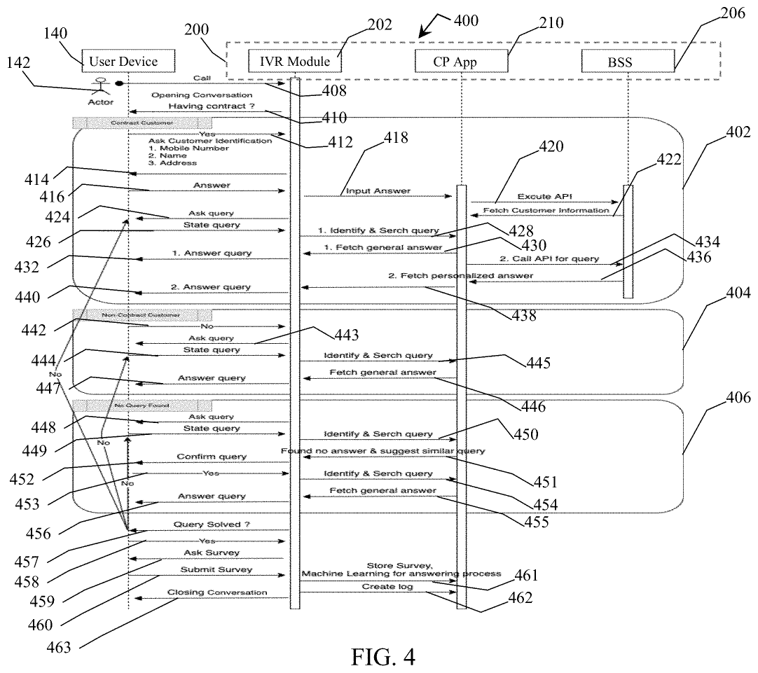

FIG. 4 is a call flow diagram 400 of an embodiment of implementing customer service procedures, in accordance with some embodiments.

The call flow diagram 400 includes 3 sets of procedures 402, 404, 406. Procedures 402 relate to procedures for a contract customer that has a customer account. Procedures 404 relate to non-contract customer that does not have a customer account. Procedures 406 relate to procedures where no query is found. The Communication Platform (CP) application 210 is an example of the AI engine 210 in FIG. 2 and the BSS 206 is one embodiment of the customer service engine 206 in FIG. 2.

Prior to procedures 402, 404, 406, the customer 142 makes a call to the customer service center (e.g., the customer service center 131 in FIG. 1) and the automated customer resolution software 200 is configured to answer and establish the call at procedure 408. At procedure 410, the automated customer resolution software 200 is configured to transmit an audible request that ask whether the customer 142 has a contract or other equivalent question.

Within procedures 402 are procedures 412, 414, 416, 418, 420, 422, 424, 426, 428, 430, 432, 434, 436, 438, 440. Flow beings at procedure 412. At procedure 412, a customer provides and the IVR module 202 receives an audible of answer of Yes to procedure 410. At procedure 414, the IVR module 202 responds with an audible query to the user device 140 of the customer 142 that asks for the customer's identification information (e.g., mobile number, name, address). At procedure 416, the customer 142 sends an audible answer with the customer's identification information. The IVR module 202 then transfers the audible data with the audible answer to the CP application 210, which is an example of the AI engine 210.

The CP application 210 is configured to convert the audible data into textual data at procedure 418. The CP application 210 sends the textual data to the BSS 206 where the BSS 206 looks up the customer information at procedure 420. At procedure 422, the BSS 206 sends the customer information to the CP application 210. The IVR module 202 then sends an audible query that asks for the customer service inquiry, at procedure 424. At procedure 426, the user device 140 sends audio to the IVR module 202 with the customer inquiry, where the IVR module 202 converts the audio into auditory data and the auditory data into textual data. The textual data is sent to the CP application 210, where the CP application 210 identifies a category of the customer inquiry and identifies a search query from the textual data at procedure 428. At procedure 430, the CP application 210 is configured to search through customer service resolution data structures based on the search query and find the customer service resolution data structures related to a target automated customer service resolution associated with a previous customer service inquiry that most closely matches the search inquiry. The target automated customer service resolution is also implemented at procedure 430. A response is provided to the customer service inquiry, which is sent by the IVR module 202 to the user device 140 at procedure 432.

In some embodiments, a call is made to a customer service representative by the BSS 206 at procedure 434. An input from the customer service representative is received by the AI engine 210 at procedure 436. In some embodiments, this occurs when the customer 142 selects to talk to a customer service representative. The AI engine 210 is configured to search through customer service resolution data structures based on the search query and find the customer service resolution data structures related to a target automated customer service resolution associated with a previous customer service inquiry that most closely matches the search inquiry at procedure 438. At procedure 440, the target automated customer service resolution is implemented and an answer to the customer service inquiry is transmitted by the IVR module 202 to the user device 140.

Within procedures 404 are procedures 442, 443, 444, 445, 446, 447. Procedures 404 relate to procedures that occur when the customer 142 is a non-contract customer and the customer service inquiry has a target automated customer service resolution. Flow begins at procedures 442. At procedure 442, a customer 142 provides and the IVR module 302 receives an audible of answer of No to procedure 410. The IVR module 202 then sends an audible query that asks for the customer 142 to provide the customer service inquiry as speech into the user device 140 at procedure 443. At procedure 444, the user device 140 sends audio to the IVR module 202 with the customer service inquiry, where the IVR module 202 converts the audio into auditory data and the auditory data into textual data. The textual data is sent to the CP application 210, where the CP application 210 identifies a category of the customer service inquiry and identifies a search query from the textual data at procedure 445. At procedure 446, the CP application 210 is configured to search through customer service resolution data structures based on the search query and find the customer service resolution data structures related to a target automated customer service resolution associated with a previous customer service inquiry that most closely matches the search inquiry. The target automated customer service resolution is also implemented at procedure 446. A response is provided to the customer service inquiry, which is sent by the IVR module 202 to the user device 140 at procedure 447.

Within procedures 406 are procedures 448, 449, 450, 451, 452, 453, 454, 455, 456. Procedures 406 relate to procedures that occur when the customer 142 is a non-contract customer and the customer inquiry does not initially find a target automated customer service resolution. These procedures assume that at procedure 442, a customer 142 provides and the IVR module 302 receives an audible of answer of No to procedure 410.

The IVR module 202 sends an audible query to the user device 140 of the customer 142 that asks for speech from the customer 142 that states the customer service inquiry, at procedure 448. At procedure 449, the user device 140 sends audio to the IVR module 202 with the customer service inquiry, where the IVR module 202 converts the audio into auditory data and the auditory data into textual data. The textual data is sent to the CP application 210, where the CP application 210 identifies a category of the customer service inquiry and identifies a search query from the textual data at procedure 450. At procedure 451, the CP application 210 is configured to search through customer service resolution data structures based on the search query. However, none of the customer service resolution data structures identify a target automated customer service resolution that matches the search inquiry. Thus, the CP application 210 suggest a similar customer service inquiry (also referred to as query or suggested query) from the previous customer inquiry in the customer service resolution data structures at procedure 451. At procedure 452, the IVR module 202 transmits an audible message to the user device 140 stating the suggested query and asking that the customer 142 confirm that the suggested customer service inquiry is applicable. At procedure 453, the customer 142 sends a response of yes through the user device 140 to the IVR module 202. At procedure 454, the IVR module 202 converts indicates that the suggested customer service inquiry is applicable so that a search is performed based on the suggested customer service inquiry. At procedure 455, the CP application 210 is configured to search through customer service resolution data structures based on the suggested search query and find the customer service resolution data structures related to a target automated customer service resolution associated with a previous customer service inquiry that most closely matches the suggested search query. The target automated customer service resolution is also implemented at procedure 455. A response is provided to the suggested query, which is sent by the IVR module 202 to the user device 140 at procedure 456.

Procedures 457, 458, 459, 460 461, 462, 463 are implemented after procedures 402, 404, and/or 406, in accordance with some embodiments. At procedure 457, the IVR module 202 sends audio to the user device 140 asking the customer 142 if the customer service inquiry was solved. If the customer 142 sends audio with an answer of no to the IVR module 202, flow proceeds to procedure 424 where procedures 424-440 are implemented, in accordance with some embodiments. If the customer 142 sends audio with an answer of no to the IVR module 202, flow proceeds to procedure 444 where procedures 444-447 are implemented, in accordance with some embodiments. If the customer 142 sends audio with an answer of no to the IVR module 202 flow proceeds to procedure 449 where procedures 449-456 are implemented, in accordance with some embodiments. Otherwise, the customer 142 sends audio with an answer of yes to the IVR module 202 at procedure 458. At procedure 459, the IVR module 202 sends audio or text to the user device 140 with a survey. At procedure 460, the IVR module 202 receives an audio or textual response to the survey from the user device 140 of the customer 142. At procedure 461, the CP application 210 stores the survey and applies a machine learning process based on the answers to the survey so that the CP application 210 learns how to select the target automated customer service resolutions (e.g., target playbooks) from the plurality of automated customer service resolutions. Furthermore, at procedure 462, a log of the procedures that were implemented is created, which creates a new automated customer service resolution in some embodiments. Finally, at procedure 463, the IVR module 202 closes the conversation and ends the call with the user device 140.

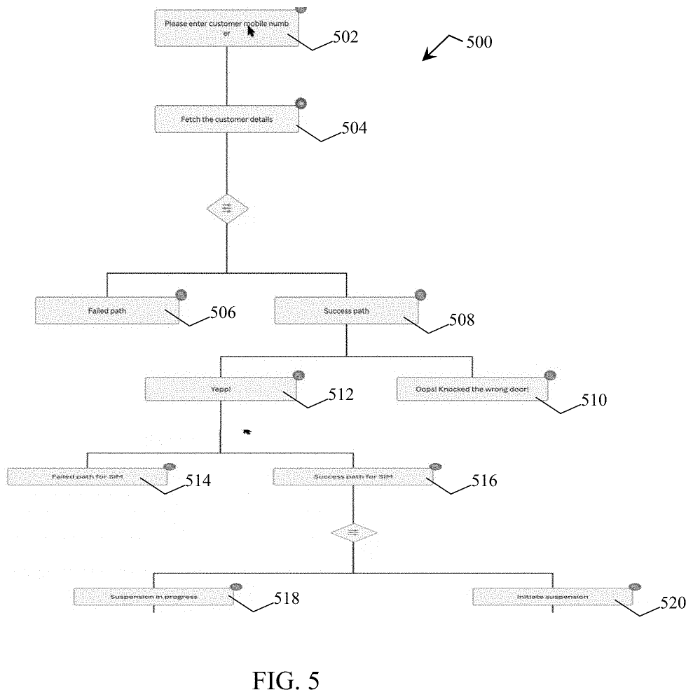

FIG. 5 is a visual representation of an automated decision tree 500, in accordance with some embodiments.

The automated decision tree 500 corresponds with the automated customer service resolutions 126 of FIG. 1, the playbooks 220 of FIG. 2, and the playbooks 320 in FIG. 3.

The automated decision tree 500 includes a set of automated procedures 502-520 that are implemented by the automated customer resolution software 122 (See FIG. 1) in an automated manner. The automated decision tree 500 relates to automated procedures 502-520 when a customer loses their mobile user device. However, this particular customer inquiry is simply exemplary. In other embodiments, the customer service inquiry is related to any type of problem, request or question related to customer service that is implementable in an automated manner or at least in a partially automated manner by the automated customer resolution software 122.

Flow begins at automated procedure 502. At automated procedure 502, the automated customer resolution software 122 requests that the customer enter their mobile number. If the mobile number is received, the automated customer resolution software 122 looks up the customer details regarding their mobile user device. If the customer details are not found, a set of procedures 506 are followed. If the customer details are found, the automated customer resolution software 122 is configured to obtain the customer details at procedure 508. At automated procedure 510, the automated customer resolution software 122 determines that information related to the mobile device's subscriber identity module (SIM) is not included in the customer details. Alternatively, at automated procedure 512, the information related to the mobile device's SIM is found. At procedure 514, the automated customer resolution software 122 is unable to connect to the SIM. Alternatively, at procedure 516, the automated customer resolution software 122 is configured to connect to the SIM. At automated procedure 518, the automated customer resolution software 122 continues suspending the operation of the SIM since a suspension operation was already started. Alternatively, at automated procedure 520, a suspension operation is initiated for the SIM.

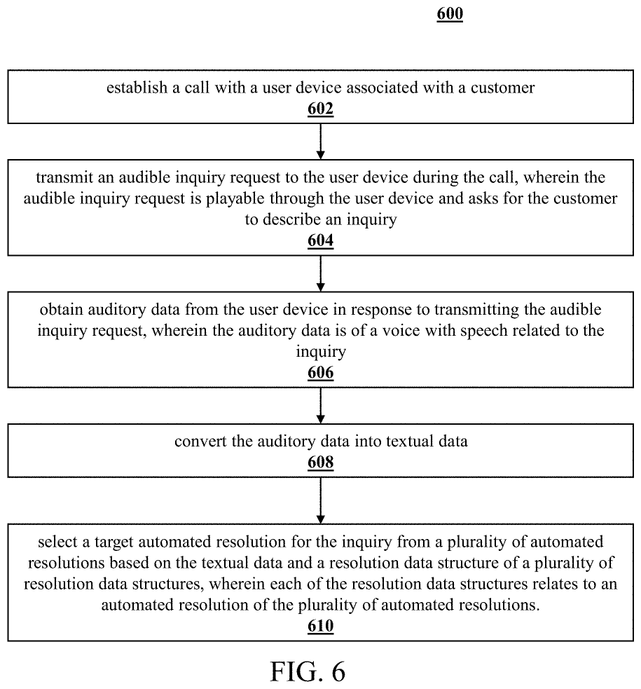

FIG. 6 is a flowchart 600 related to a customer service method, in accordance with some embodiments.

Flowchart 600 is implemented by the automated customer resolution software 122 in FIG. 1, the automated customer resolution software 200 in FIG. 2, or the automated customer resolution software 300 in FIG. 3, in accordance with some embodiments. Flowchart 600 includes blocks 602-610. Flow begins at block 602.

At block 602, a call with a user device associated with a customer. An example of block 602 is procedure 408 in FIG. 4. An example of a user device is user device 140 in FIG. 1. An example of a customer is customer 142 in FIG. 1 and FIG. 4, customer 212 in FIG. 2, and customer 312 in FIG. 3. Flow then proceeds to block 604.

At block 604, an audible inquiry request is transmitted to the user device during the call, wherein the audible inquiry request is playable through the user device and asks for the customer to describe an inquiry. An example of block 604 is shown in procedure 424, procedure 443, and procedure 448 in FIG. 4. Flow then proceeds to block 606.

At block 606, auditory data is obtained from the user device in response to transmitting the audible inquiry request, wherein the auditory data is of a voice with speech related to the inquiry. An example of block 606 is shown as procedure 426, procedure 444, and procedure 449 in FIG. 4. An example of auditory data is shown as auditory data 123 in FIG. 1. Flow then proceeds to block 608.

At block 608, the auditory data is converted into textual data. Examples of block 608 include portions of procedure 428, procedure 450, and procedure 451 in FIG. 4. An example of the textual data includes textual data 124 in FIG. 1. Flow then proceeds to block 610.

At block 610, a target automated resolution is selected for the inquiry from a plurality of automated resolutions based on the textual data and a resolution data structure of a plurality of resolution data structures, wherein each of the resolution data structures relates to an automated resolution of the plurality of automated resolutions. Examples of block 610 include procedure 430, procedure 446, and procedure 455. Examples of automated resolutions includes automated customer service resolutions 126, playbooks 220 in FIG. 2, playbooks 320 in FIG. 3, and the automated decision tree 500 in FIG. 5. Example of resolution data structures include customer service resolution data structures 125 in FIG. 1.

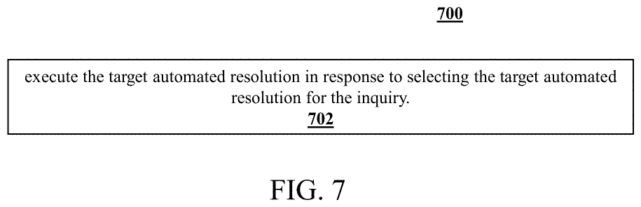

FIG. 7-FIG. 9 include different flowcharts 700, 800, 900 that are implemented after the flowchart 600.

In some embodiments, flowchart 700 is implemented after flowchart 600 while flowcharts 800, 900 are not implemented.

In some embodiments, flowchart 800 is implemented after flowchart 600 while flowcharts 700, 900 are not implemented.

In some embodiments, flowchart 900 is implemented after flowchart 600 while flowcharts 700, 800 are not implemented.

Flowchart 700 includes block 702. At block 702, the target automated resolution is executed in response to selecting the target automated resolution for the inquiry. In some embodiments, no additional procedures or blocks are executed between block 610 and block 702. In some embodiments, examples of block 702 are included in procedure 430, procedure 446, and procedure 455

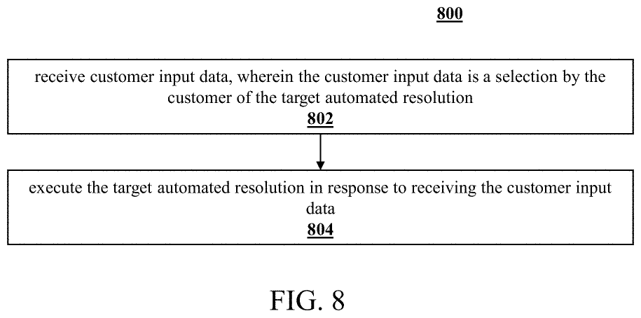

In FIG. 8, flowchart 800 includes block 802-804. In some embodiments, block 802 begins after block 610. At block 802, customer input data is received, wherein the customer input data is a selection by a customer of the target automated resolution. In some embodiments, the automated customer resolution software 122 first ask the customer whether the customer 142 would like to implement the target automated customer service resolution 126 resulting from the search of the customer service resolution data structures 125. Flow then proceeds to block 804.

At block 804, the target automated resolution is executed in response to receiving the customer input data. In some embodiments, if the customer 142 answers that yes, the customer would like to implement the target automated customer service resolution 126. In response, the automated customer resolution software 122 implements the target automated customer service resolution 126.

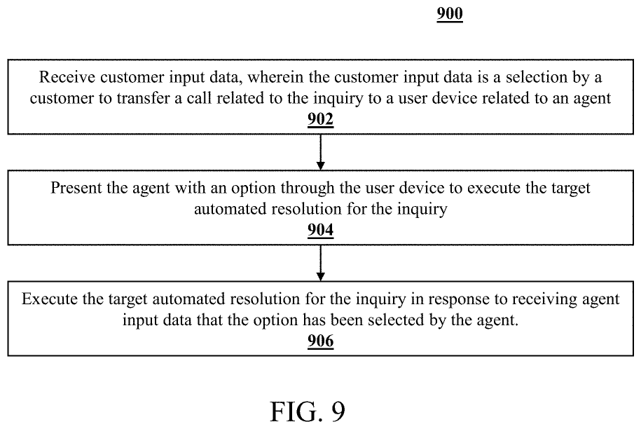

In FIG. 9, flowchart 900 includes block 902-906. In some embodiments, block 902 begins after block 610. At block 802, customer input data is received, wherein the customer input data is a selection by a customer to transfer a call related to the inquiry to a user device related to an customer service representative. In some embodiments, the automated customer resolution software 122 first ask the customer whether the customer 142 would like to talk to an customer service representative. Examples of the user device include user device 130 in FIG. 1. Examples of the customer service representative are the customer service representative 132 shown in FIG. 1 and the customer service representative 330 shown in FIG. 3. In some embodiments, the customer answers yes meaning that the customer would like to talk to the customer service representative. Flow then proceeds to block 904.

At block 904, the customer service representative is presented with an option through the user device to execute the target automated resolution for the inquiry. Flow then proceeds to block 906.

At block 906, the target automated resolution is executed in response to receiving customer service representative input data that the option has been selected by the customer service representative. In some embodiments, the customer service representative 132 decides after listening to the customer 142 that the target automated customer service resolution 126 is the best way to resolve the problem and selects the option through the user device 130. In response, the automated customer resolution software 122 implements the target automated customer service resolution 126.

In some embodiments, a method, includes: converting auditory data into textual data, wherein the auditory data is of a voice with speech related to an inquiry; and selecting, using a computer device, a target automated resolution for the inquiry from a plurality of automated resolutions based on the textual data and a resolution data structure of a plurality of resolution data structures, wherein each of the resolution data structures relates to an automated resolution of the plurality of automated resolutions. In some embodiments, the method further includes executing the target automated resolution in response to selecting the target automated resolution for the inquiry. In some embodiments, the method further includes receiving customer input data, wherein the customer input data is a selection by a customer of the target automated resolution; and executing the target automated resolution in response to receiving the customer input data. In some embodiments, the method further includes: receiving customer input data, wherein the customer input data is a selection by a customer to transfer a call related to the inquiry to a user device related to an customer service representative; presenting the customer service representative with an option through the user device to execute the target automated resolution for the inquiry; and executing the target automated resolution for the inquiry in response to receiving customer service representative input data that the option has been selected by the customer service representative. In some embodiments, the target automated customer service resolution includes an automated decision tree. In some embodiments, the method of claim further includes establishing a call with a user device associated with a customer; transmitting audible inquiry request to the user device during the call, wherein the audible inquiry request is playable through the user device and asks for the customer to describe a customer service inquiry; obtaining the auditory data from the user device in response to transmitting the audible inquiry request. In some embodiments, selecting, using the computer device, the target automated resolution for the inquiry based on the textual data and the resolution data structures includes implementing an artificial intelligence (AI) engine that is configured to select the automated resolution for the inquiry based on the textual data and the resolution data structures.

In some embodiments, a computer system, includes: a non-transient computer readable medium that stores computer executable instructions; at least one processor operably associated with the non-transient computer readable medium, wherein when the at least one processor executes the computer executable instructions, the processor is configured to: convert auditory data into textual data, wherein the auditory data is of a voice with speech related to an inquiry; and select a target automated resolution for the inquiry from a plurality of automated solutions based on the textual data and the resolution data structures, wherein each of the resolution data structures relates to an automated resolution of the plurality of automated resolutions. In some embodiments, the at least one processor is further configured to execute the target automated resolution in response to selecting the target automated resolution for the inquiry. In some embodiments, the at least one processor is further configured to: receive customer input data, wherein the customer input data is a selection by a customer of the target automated resolution; and execute the target automated resolution in response to receiving the customer input data. In some embodiments, the at least one processor is further configured to: receive customer input data, wherein the customer input data is a selection by a customer to transfer a call related to the inquiry to a user device related to a customer service representative; present the customer service representative with an option through the user device to execute the target automated resolution for the inquiry; and execute the target automated resolution for the inquiry in response to receiving customer service representative input data that the option has been selected by the customer service representative. In some embodiments, the target automated resolution includes an automated decision tree. In some embodiments, the at least one processor is further configured to: establish a call with a user device associated with a customer; transmit audible inquiry request to the user device during the call, wherein the audible inquiry request is playable through the user device and asks for the customer to describe a customer service inquiry; obtain the auditory data from the user device in response to transmitting the audible inquiry request. In some embodiments, the at least one processor is configured to select, using the computer device, the target automated resolution for the inquiry based on the textual data and the resolution data structures by: implementing an artificial intelligence (AI) engine that is configured to select the automated resolution for the inquiry based on the textual data and the resolution data structures.

In some embodiments, a non-transient computer readable medium that stores computer executable instructions, wherein when at least one processor executes the computer executable instructions, the processor is configured to: convert auditory data into textual data, wherein the auditory data is of a voice with speech related to an inquiry; and select a target automated resolution for the inquiry from a plurality of automated solutions based on the textual data and the resolution data structures, wherein each of the resolution data structures relates to an automated resolution of the plurality of automated resolutions. In some embodiments, the at least one processor is further configured to execute the target automated resolution in response to selecting the target automated resolution for the inquiry. In some embodiments, the at least one processor is further configured to: receive customer input data, wherein the customer input data is a selection by a customer of the target automated resolution; and execute the target automated resolution in response to receiving the customer input data. In some embodiments, the at least one processor is further configured to: receive customer input data, wherein the customer input data is a selection by a customer to transfer a call related to the inquiry to a user device related to a customer service representative; present the customer service representative with an option through the user device to execute the target automated resolution for the inquiry; and execute the target automated resolution for the inquiry in response to receiving customer service representative input data that the option has been selected by the customer service representative. In some embodiments, the at least one processor is further configured to: establish a call with a user device associated with a customer; transmit audible inquiry request to the user device during the call, wherein the audible inquiry request is playable through the user device and asks for the customer to describe a customer service inquiry; obtain the auditory data from the user device in response to transmitting the audible inquiry request. In some embodiments, the at least one processor is configured to select, using the computer device, the target automated resolution for the inquiry based on the textual data and the resolution data structures by: implementing an artificial intelligence (AI) engine that is configured to select the automated resolution for the inquiry based on the textual data and the resolution data structures.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

1. A computer-implemented method, comprising:
converting auditory data into textual data, wherein the auditory data is of a voice with speech related to an inquiry received from a user device associated with a customer; and
selecting, using a computer device, a target automated resolution for the inquiry from a plurality of automated resolutions based on the textual data and a resolution data structure of a plurality of resolution data structures,
wherein each of the resolution data structures relates to an automated resolution of the plurality of automated resolutions, and
wherein said converting and selecting are performed even where the customer is a non-contract customer that does not have a customer account.

2. The method of claim 1, further comprising executing the target automated resolution in response to selecting the target automated resolution for the inquiry.

3. The method of claim 1, further comprising:
receiving customer input data, wherein the customer input data is a selection by the customer of the target automated resolution; and
executing the target automated resolution in response to receiving the customer input data.

4. The method of claim 1, further comprising:
receiving customer input data, wherein the customer input data is a selection by the customer to transfer a call related to the inquiry to a user device related to a customer service representative;
presenting the customer service representative with an option through the user device to execute the target automated resolution for the inquiry; and
executing the target automated resolution for the inquiry in response to receiving customer service representative input data.

5. The method of claim 1, wherein the target automated resolution comprises an automated decision tree.

6. The method of claim 1, further comprising:
establishing a call with the user device associated with the customer;
transmitting an audible inquiry request to the user device during the call, wherein the audible inquiry request is playable through the user device and asks for the customer to describe a customer service inquiry;
obtaining the auditory data from the user device in response to transmitting the audible inquiry request.

7. The method of claim 1, wherein selecting, using the computer device, the target automated resolution for the inquiry based on the textual data and the plurality of resolution data structures comprises:
implementing an artificial intelligence (AI) engine that is configured to select the target automated resolution for the inquiry based on the textual data and the plurality of resolution data structures.

8. (canceled)

9. The computer system of claim 11, wherein the at least one processor is further configured to execute the target automated resolution in response to selecting the target automated resolution for the inquiry.

10. The computer system of claim 11, wherein the at least one processor is further configured to:
receive customer input data, wherein the customer input data is a selection by a customer of the target automated resolution; and
execute the target automated resolution in response to receiving the customer input data.

11. A computer system, comprising:
a non-transient computer readable medium that stores computer executable instructions;
at least one processor operably associated with the non-transient computer readable medium, wherein when the at least one processor executes the computer executable instructions, the processor is configured to:
convert auditory data into textual data, wherein the auditory data is of a voice with speech related to an inquiry;
select a target automated resolution for the inquiry from a plurality of automated solutions based on the textual data and resolution data structures, wherein each of the resolution data structures relates to an automated resolution of a plurality of automated resolutions;
receive customer input data, wherein the customer input data is a selection by a customer to transfer a call related to the inquiry to a user device related to a customer service representative;
present the customer service representative with an option through the user device to execute the target automated resolution for the inquiry; and
execute the target automated resolution for the inquiry in response to receiving customer service representative input data that the option has been selected by the customer service representative.

12. The computer system of claim 11, wherein the target automated resolution comprises an automated decision tree.

13. The computer system of claim 11, wherein the at least one processor is further configured to:
establish a call with a user device associated with a customer;
transmit audible inquiry request to the user device during the call, wherein the audible inquiry request is playable through the user device and asks for the customer to describe a customer service inquiry;
obtain the auditory data from the user device in response to transmitting the audible inquiry request.

14. The computer system of claim 11, wherein the at least one processor is configured to select the target automated resolution for the inquiry based on the textual data and the resolution data structures by:
implementing an artificial intelligence (AI) engine that is configured to select the automated resolution for the inquiry based on the textual data and the resolution data structures.

15. A non-transient computer readable medium that stores computer executable instructions, wherein when at least one processor executes the computer executable instructions, the processor is configured to:
convert auditory data into textual data, wherein the auditory data is of a voice with speech related to an inquiry; and
select a target automated resolution for the inquiry from a plurality of automated solutions based on the textual data and resolution data structures by implementing an artificial intelligence (AI) engine that is configured to select the automated resolution for the inquiry based on the textual data and the resolution data structures,
wherein each of the resolution data structures relates to an automated resolution of a plurality of automated resolutions, and
wherein the AI engine comprises rule base intelligence, machine learning base intelligence, and natural language processing.

16. The non-transient computer readable medium of claim 15, wherein the at least one processor is further configured to execute the target automated resolution in response to selecting the target automated resolution for the inquiry.

17. The non-transient computer readable medium of claim 15, wherein the at least one processor is further configured to:
receive customer input data, wherein the customer input data is a selection by a customer of the target automated resolution; and
execute the target automated resolution in response to receiving the customer input data.

18. The non-transient computer readable medium of claim 15, wherein the at least one processor is further configured to:
receive customer input data, wherein the customer input data is a selection by a customer to transfer a call related to the inquiry to a user device related to a customer service representative;
present the customer service representative with an option through the user device to execute the target automated resolution for the inquiry; and
execute the target automated resolution for the inquiry in response to receiving customer service representative input data that the option has been selected by the customer service representative.

19. The non-transient computer readable medium of claim 15, wherein the at least one processor is further configured to:
establish a call with a user device associated with a customer;
transmit audible inquiry request to the user device during the call, wherein the audible inquiry request is playable through the user device and asks for the customer to describe a customer service inquiry;
obtain the auditory data from the user device in response to transmitting the audible inquiry request.

20. (canceled)

21. The computer system of claim 14, wherein the AI engine comprises rule base intelligence, machine learning base intelligence, and natural language processing.

22. The computer system of claim 21, wherein the at least one processor is configured to convert the auditory data into the textual data and select the target automated resolution even where the inquiry is received from a user device associated with a customer who is a non-contract customer that does not have a customer account.
